(19) United States
(12) Patent Application Publication
(10) Pub. No.: US 2026/0350561 A1
(43) Pub. Date: Nov. 5, 2026

(54) SECURE ELEMENT, METHOD FOR REGISTERING TOKENS, AND TOKEN REFERENCE REGISTER

(71) Applicant: GIESECKE+DEVRIENT ADVANCE52 GMBH, Munchen (DE)

(72) Inventors: Klaus ALFERT, St. Augustin (DE); Lars HUPEL, Munchen (DE); Matthias FASCHING, Unterhaching (DE); Peter ZELLER, Schwalbach am Taunus (DE)

(21) Appl. No.: 19/099,231

(22) PCT Filed: Jun. 28, 2023
(86) PCT No.: PCT/DE2023/100487

§ 371 Date: Jan. 28, 2025

(30) Foreign Application Priority Data
Aug. 1, 2022 (DE) 10 2022 002 780.1

(51) Int. Cl. G06Q 20/06; G06Q 20/36; G06Q 20/38; G06Q 20/40

(52) U.S. Cl. CPC G06Q 20/0655; G06Q 20/3676; G06Q 20/3678; G06Q 20/3825; G06Q 20/401

(57) ABSTRACT

A secure element as a transaction unit of a transaction system has a token reference register, to a procedure in the token reference register, and to the token reference register. The secure element has a token store for tokens of the transaction system and is designed as a transaction unit for exchanging tokens of the transaction system directly with another transaction unit of the transaction system. Each token of the transaction system is unambiguously assigned a token reference, which can be registered in a token reference register of the transaction system. The secure element is designed in order to produce at least one output token and an output token reference thereof. The secure element provides a modification detail, a command and an output token reference. The secure element provides the at least one modification detail as a validity enquiry, and to receive a validity confirmation for an output token reference.

The invention relates to a method for registering tokens, in particular of a secure element as a transaction unit, to a secure element, and to a token reference register that stores token references which are uniquely assigned to a token, and to the transaction system as a whole.

With the aid of secure elements, such as chip cards, SIM modules, etc., as transaction units, it is known that a secure direct transmission between the transaction units can be achieved, in which case deliberate multiple issues of tokens, also called double spending, are already excluded.

For example, DE 10 2009 038 645 A1 and DE 10 2009 034 436 A1 disclose systems and portable data carriers as secure elements for transferring monetary amounts in the form of electronic data records, in which payment with duplicates of the data record is prevented and there is a high degree of tamper protection. Complex structures and complicated encryption and signing processes are required here for the transactions.

The security of transactions and the associated transaction data includes both protecting the confidentiality of the exchanged data; and protecting the integrity of the exchanged data; and protecting the availability of the exchanged data.

A distinction is often made between token-based systems and account-based systems as solution approaches for secure transaction systems. In addition to conventional account-based systems, such as credit accounts, more innovative account-based systems based on blockchain topologies have recently been discussed. The account-keeping unit respectively has access to the data record representing the monetary amount. Although the more innovative account-based systems provide a high level of integrity protection, they also publish a lot of information, for example when data records are in a freely readable data structure and change ownership there.

It is also already known practice to expand a token-based transaction system with a token register. The secure element sends a registration request for its token to the register. The register verifies the registration request and, for example, stores only a token reference for the token, that is to say it does not know the token itself.

WO 2020/212337 A1 describes a transaction system in which even modifications of tokens, for example by splitting the token, are securely possible offline, i.e. directly between the secure elements of the transaction system and without any further supervisory authority. After being received in a secure element or a subscriber unit, the tokens can be immediately transferred further without the need to register a modification in a token register of the transaction system. The modification can be registered in the token register temporally independently of the actual transaction, the transfer of the token. However, the secure elements are known to be resource-constrained, especially constrained in terms of storage space, processing speed, transfer time and/or speed.

The invention is based on the object of providing a new method which is better suited to a secure element as a transaction unit, that is to say is resource-saving, in particular. The processes in the transaction system, such as the direct transfer of the tokens between the transaction units and the registration of tokens in the register, as well as the associated advantages and possible uses, should preferably be retained. In particular, a plurality of modification statements of a transaction unit should also be processed in a resource-saving manner.

The stated object is achieved by the features described in the independent patent claims. Further advantageous configurations are described in the respectively dependent patent claims.

A secure element of an electronic transaction system has a token store for tokens of the transaction system and is configured to exchange tokens directly with another transaction unit of the transaction system. A token reference is uniquely assigned to each token of the transaction system. Token references (and thus the assigned tokens) can be registered in a token reference register of the transaction system. The secure element is also configured to generate at least one output token and its output token reference from at least one input token. The secure element provides at least one modification statement for the token reference register, which statement comprises at least one input token reference, a command, and at least one output token reference.

Now, the secure element provides the at least one modification statement as a validity request and receives a validity confirmation for at least one output token reference of the validity request that is to be checked for validity.

Sending the modification statement in a validity request enables, as explained in more detail below, a multiplicity of initially seemingly rather small advances which can be helpful at the latest in the sum for the secure element and even for the token reference register. Since the token reference register can process the validity request with an (only optional) modification statement on average faster than a conventional registration request, the connection or transfer time is already reduced and thus the effort in the secure element needed to manage, in particular maintain (timeouts . . . ) or restore, the connection.

The validity request may preferably comprise the at least one output token reference to be checked and at least one output token reference not to be checked. Therefore, not all output token references need to be checked for validity.

The validity request may comprise the modification statement and, in addition, a checking statement which indicates the at least one (or more) output token reference(s) to be checked. For example, the checking statement may contain the output token reference(s), may contain a (or the) reference(s) to the output token references, or may also be coded by one (or more) flag(s) set for the output token reference(s). Flags are usually bits that are either set or not set. For example, a flag that can either be set or not set would be provided for each output token reference of the validity request or the modification statement. Particularly preferably, the checking statement relates to output token references of at least two different modification statements of the validity request.

In particular, for the benefit of the token reference register, the secure element could be configured to provide modification statements either as a validity request or as a registration request. For example, the secure element could use the following as a selection criterion for sending as a validity request:
a number of modification statements stored in the secure element, in particular from more than two modification statements, and/or
a time criterion, in particular with the aid of a time stamp, for example a transaction and/or modification or the last communication with the token reference register, and/or
a criterion of origin, for example if the modification statement has been received, in particular from another transaction unit.
   However, such a selection by the secure element is not really necessary. As will also become clear below, the secure element can always send one (or more) modification statement(s) as a validity request.

In principle, it is conceivable to cryptographically protect, i.e. to encrypt and/or sign, the data exchange with the token reference register, including the validity request and confirmation. In particular, a validity confirmation manipulated by third parties would be detected in this way.

It is particularly advantageous (and sufficient for protecting a validity request) if the validity confirmation comprises a separate cryptographic confirmation, such as a checksum or signature, for each output token reference to be checked. It may also be advantageous if the validity confirmation comprises a common cryptographic confirmation, such as a checksum or signature, for all the output token references to be checked (or only for these). The cryptographic confirmation(s) for the output token reference(s) to be checked is/are preferably stored in the secure element and/or transferred together with the assigned token(s) to another transaction unit.

The validity request may comprise a plurality of modification statements, in particular comprise a stack and/or at least one sequence of modification statements. Modification statements that are independent of each other (in their token references) are referred to as a stack in the present case. The modification statements in a stack can be processed in any order in the token reference register. In contrast, modification statements that are dependent on each other (in their token references) are referred to as a sequence. At least one output token reference of a modification statement is also the input token reference of another modification statement. Preferably, the sequence comprises a plurality of output token references which are also the input token reference of a subsequent modification statement in the sequence. The modification statements in a sequence cannot be processed in any order in the token reference register. The token reference register will execute the modification statements in the sequence(s) in particular in the order in which they are present in the validity request or specified in the validity request. The sequence can be set up in particular with or without branches, only for example “MA1=>MA2=> . . . =>MAn” or “(MA1, MA2)=>MA3 . . . (MA4, MA5)=>MA6 . . . ”.

In particular, the modification statement(s) of the validity request must only be executed as an option. The token reference register can send a validity confirmation even in the event of one (or more) erroneous modification statement(s). Whether the token reference register checks the modification statement(s) and executes it/them if necessary, and/or which of the modification statements have been checked and executed, is independent of the validity confirmation for the at least one (or more) output token reference(s) to be checked.

The validity request may be a request for a token reference register, which stores only the valid token references in a storage unit for token references, to check whether the output token reference(s) to be checked is (are) already stored in the storage unit.

The secure element usually comprises a processor, in particular for carrying out the steps as a transaction unit, and/or an interface, in particular to a local terminal, via which the validity request for the token reference register (TRR) is provided. A transaction unit can be a subscriber unit or is sometimes also referred to as such below.

The or each token will comprise as data elements in particular a token value and a secret token element, which is in particular a secret key of a key pair. Token references may comprise as data elements a token value, in particular the token value of the token, as well as a public token element, in particular the public key of the key pair of the token.

A modification is in particular a splitting and/merging or switching of tokens. The command of the modification statement is accordingly, for example, “split”, “merge” or “switch”. One (or more) input tokens with a (total) token value can be split into a plurality of output tokens with a different token value (but the same total value). Two or more input tokens with a total value can be merged to form an output token with the total value. An input token with a token value can be switched to an output token with the same token value.

The transaction unit, i.e., for example, the security element, can generate one (or more) output token(s), in particular including the token value and secret token element, as well as the assigned output token reference for the modification statement.

The transaction unit, i.e., for example, the security element, stores its tokens and optionally one or more modification statements. The modification statement is stored together with or at least linked to the output token.

The security element can preferably delete the modification statement(s) which is/are stored in the security element and was/were included in the validity request in response to the receipt of the validity confirmation.

Tokens can be exchanged directly with other transaction units. For as yet unregistered tokens, the token must be transferred together with the modification statement(s). Already registered tokens can be transferred without the modification statement.

A method for checking the validity of a token of a secure electronic transaction system is provided in the present case. A token reference is uniquely assigned to each token of the transaction system. A token reference register of the transaction system comprises a verification unit and a storage unit, in which the token references of valid tokens are stored. The following steps are carried out in the token reference register:
receiving a validity request comprising a modification statement with at least one input token reference, at least one output token reference and a command;
checking at least one output token reference of the validity request that is to be checked for validity in order to determine whether it is stored in the storage unit; and
sending a validity confirmation for the at least one output token reference to be checked.
   The validity request comprises a checking statement which indicates the at least one output token reference to be checked, and/or the modification statement to be processed only as an option.

The checking (and optionally the receiving and sending) is preferably carried out by the verification unit of the token reference register. The receiving and sending can be carried out by an interface unit of the token reference register.

Preferably, the verification unit processes modification statements, i.e. optionally also the modification statement(s) of the validity request, using one or more of the following substeps:
checking whether the at least one input token reference is stored in the storage unit; and/or
verifying the modification statement, in particular one (or more) signature(s) in the modification request and/or a value neutrality of the modification statement and/or a syntax of the modification statement; and/or
executing the command (or the modification statement) by storing an output token reference in the storage unit and in particular by deleting an input token reference in the storage unit.
   In advantageous configurations, the validity confirmation is sent—in particular without further processing of the modification statement—if the output token reference(s) of the validity request that is/are to be checked is/are already stored in the storage unit. Otherwise, the modification statement(s) is/are processed. The validity confirmation can be sent alternatively or additionally after the processing of the (one or more) modification statement(s) to be processed only as an option has been omitted completely or in substeps, i.e. none of the substeps has been carried out or not all substeps have been carried out.

The validity request preferably comprises at least one, further preferably a plurality of, output token reference(s) not to be checked for validity. The validity confirmation (GB) may comprise a separate cryptographic confirmation, such as a signature or checksum, for each output token reference to be checked.

The output token reference to be checked for validity does not have to be explicitly indicated in the checking statement of the validity request. It can be one of the output token references included in the modification statement. However, the token reference(s) to be checked is (are) preferably received from the token reference register in the checking statement, as a separate data element of the validity request. The checking statement may be formed by one (or more) reference(s) to the output token reference(s) to be checked (for example the position or number of the output token reference in the validity request) or may contain the output token reference(s).

The validity request may comprise a plurality of modification statements, wherein each modification statement comprises one or more input token references, one or more output token references and a command. The modification statements are preferably a stack of modification statements and/or a sequence of modification statements. Stacks consist of independent modification statements. Sequences consist of at least partially interdependent modification statements.

The token to be checked can be transferred directly between two transaction units of the transaction system in the direct transaction layer of the transaction system (but does not yet need to have been transferred). The token to be checked was preferably modified in a transaction unit without the token having been registered in the transaction system.

The validity confirmation is also preferably sent if some of the plurality of modification statements cannot be executed (that is to say it is sometimes not possible to assign the token references to tokens of the transaction system), in particular if this/these modification(s) has/have only been made in the direct transaction layer without registering the modification(s) in the token reference register. It is therefore not a prerequisite of the validity check that all modification statements of a validity request can be tracked or executed by the verification unit. Only the assignment of the at least one token reference to be checked must be able to be verified. This means that verification is carried out independently of a registration of one or more modifications from the modification statement in the token reference register.

The verification unit of the token reference register can send storage queries and/or storage instructions to the storage unit of the token reference register. For example, it can thus query whether a token reference is stored in the storage unit and/or can instruct storage or deletion of a token reference. Preferably, the verification unit sends a common storage query for output token references of different modification statements and/or for output token references and input token references of at least one modification statement to the storage unit.

In particular, the token reference register can send a partial validity confirmation for a stack of modification statements in the validity request. The partial validity confirmation preferably concerns the valid output token references of the output token references of the stack that are to be checked for validity.

For a sequence of modification statements in the validity request, the verification unit can only internally buffer (i.e. not store in the storage unit) at least one (or) output token reference(s) of at least one modification statement. The buffered output token reference(s) is/are discarded if it/they is/are the input token reference of another modification statement or is/are otherwise stored in the storage unit. At least one (or more) output token reference(s) of a modification statement is/are not stored in the storage unit until one, a plurality of or all other modification statements in the sequence has/have been checked.

The token reference register can carry out the method with a transaction unit or the secure element that has already been described.

The token reference register may further comprise further verification units and/or an archive unit which stores token references that are no longer valid and/or validity requests and/or registration requests that have already been executed.

A token reference register for a transaction system is configured to carry out one of the aforementioned methods, in particular with a transaction unit TE of the transaction system or with one of the aforementioned secure elements.

The token reference register comprises the storage unit for storing the valid token references in the transaction system; an interface configured to receive a validity request and the at least one verification unit.

A transaction system comprises a register layer with the token reference register; and a direct transaction layer with a multiplicity of transaction units, including a secure element.

The validity requests in the transaction system can be distributed to different verification units of a token reference register and these can therefore be processed in parallel by different verification units of the token reference register. This allows a large number of validity requests to be divided internally among different verification units in the token reference register (“load balancing”).

The validity confirmation and/or the valid output token reference(s) to be checked is/are preferably signed with a private part of a key pair of the token reference register, preferably of the verification unit (possibly one of a multiplicity of verification units). This signature is checked by the transaction unit, upon receipt of the validity confirmation, with the public part of the key pair of the token reference register. This increases security, since validity confirmations that are generated by unauthorized third parties—for example during man-in-the-middle attacks—are recognized by a transaction unit due to a missing or invalid signature. Such validity confirmations can then be ignored by the transaction unit.

A token is a data record of a transaction system that can be exchanged directly between transaction units. With knowledge of the token, the receiving transaction unit is in possession of the token value represented by the token. When exchanged, the token accordingly automatically changes owner. A token—a data record that can be transferred independently of a transaction topology, such as blockchain topologies—can be transferred directly between transaction units without interposed units.

In one configuration, the token is an electronic coin data record or payment token in order to exchange monetary amounts between transaction units. Colloquially, such a payment token is also referred to as a “digital coin” or “electronic coin” and represents cash in electronic form.

Each token in the transaction system is a data record comprising at least two token elements.

A first token element of each token of the transaction system is a token value, for example an asset value, an asset, a commodity and/or a monetary amount.

A second token element of each token of the transaction system is a private part of a token-specific key pair. This private part is a secret in the transaction system and is not published and must not be used repeatedly. The generation of the private part must not be predictable. This private part may be a random number. The random number is preferably the result of a true random number generator.

The token is formed from the token value (first token element) and the private part. This forming is preferably the concatenation of these two token elements. Any other type of combination of these two token elements is not excluded according to the invention and comprises, for example, successive attachment, introduction into a TLV data structure and/or logical combination.

Anyone in possession of a token or with unrestricted access to the token with its token elements can exchange this token with another transaction unit. Possession of the token with its at least two token elements (token value and private part of the token-specific key pair) is thus equivalent to possession of the value represented by the token.

Each token in the transaction system is assigned a token reference. This assignment is biunique, that is to say exactly one token reference is assigned to a token and exactly one token is assigned to each token reference. The token reference is a public data record which is stored in a verifiable manner for each transaction unit in a storage unit of the token reference register of the transaction system.

Both the token and the token reference are unique. The biunique assignment results in a 1-to-1 relationship between the token and the token reference.

Each token reference in the transaction system is a data record comprising at least two token reference elements.

A first token reference element of each token reference is the token value of the token uniquely assigned to the token reference. The token value of the token is thus identical to the token value of the assigned token reference. By way of example, the token value of the token reference is a copy of the token value of the assigned token.

A second token element of each token reference of the transaction system is a public part of the token-specific key pair. This public part of the token reference forms, together with the private part of the token, the token-specific key pair. The public part is obtained by applying a cryptographic function to the private part.

This cryptographic function is a one-way function. Accordingly, this cryptographic function is a mathematical function that is “easy” to calculate in terms of complexity theory, but is “difficult” to practically impossible to reverse. In this case, a one-way function also denotes a function for which there has hitherto been no known reversal that can be performed in practice within a reasonable time and with reasonable effort. Preferably, use is made of a one-way function which operates on a group in which the discrete logarithm problem is difficult to solve, for example a cryptographic method analogous to an elliptic curve encryption, ECC for short, from a private key of a corresponding cryptographic method. The reverse function, that is to say the generation of a token (or of the part of the electronic coin data record) from a token reference, is very time-consuming in this case.

The (mere) knowledge or the possession of a token reference does not authorize the owner to use/transfer/output the token value (token reference element). This represents a significant difference between the token reference and the token and is a core element of the present invention.

After applying the cryptographic function to the private part of the token-specific key pair, the public part of the token-specific key pair is obtained as the second token reference element.

The token reference is formed from the token value (first token reference element) and the public part. This forming is preferably the concatenation of these two token reference elements.

Any other type of combination of these two token reference elements is not excluded according to the invention and comprises, for example, successive attachment, introduction into a TLV data structure and/or logical combination.

A token reference can preferably be generated by an electronic wallet of a transaction unit. For this purpose, the transaction unit must have knowledge of the token with its token elements. The token reference can be generated by an electronic wallet of a transaction unit that would like to send the token. Alternatively, the token reference can be generated by an electronic wallet of a transaction unit that received the token.

The use of a token reference is not comparable to the use of addresses of transaction units in a blockchain-based transaction system, since no addresses of the transaction units are used in the token reference register according to the invention to prevent traceability of the tokens.

The token reference register is a unit of the transaction register that stores the token references, as a result of which the tokens are registered as valid tokens. This register may be a central database or storage unit. This register can be a decentralized ledger. The token reference register can maintain a history of the token references and/or the registration requests and/or the validity requests separately in an archive unit.

A token reference is stored only once in the token reference register. Since a token reference of a token is present only once in the transaction system, the verification step can be used to determine whether an attempt has been made to output a token multiple times.

The token is stored in a token store that can be exclusively accessed by the transaction unit. This token store may have a multiplicity of tokens; for example, the multiplicity of tokens can be stored in a data store of the transaction unit. For example, the data store can be internal, external or virtual. In one configuration, upon receiving a token, a “merging” can take place automatically, with the result that preferably only one (or a certain number of) token(s) is/are stored in the transaction unit.

For example, the transaction unit can be a mobile terminal, such as a smartphone, a tablet computer, a computer, a server or a machine. The transaction unit can be a smart card that is inserted into a terminal such that it is ready for operation. The transaction unit is preferably a secure element.

For example, the data store is a wallet store of an electronic wallet. The electronic wallet is, for example, a software application that is stored in executable form on a transaction unit. The electronic wallet can allow the transaction unit to participate in the transaction system. This allows the electronic wallet to generate a validity request in order to have the validity of a token checked.

In addition, the electronic wallet can make modifications (switching, merging, splitting) to a token and can generate the validity request that may be necessary and can send it to the token reference register. In addition, the electronic wallet can transfer tokens to another wallet (in another transaction unit).

A transaction in the transaction system is preferably atomic.

The invention provides a token reference register for a transaction system, configured to carry out the method steps according to the method described above.

The token reference register may be configured to receive a multiplicity of validity requests which are verified in a parallel manner in a plurality of verification units in order to determine whether the at least one token reference contained in the respectively received validity request is valid.

The invention provides a transaction system comprising a register layer with a token reference register of the above type for registering token references and checking tokens by means of token references, and a direct transaction layer having a multiplicity of transaction units configured to directly exchange tokens with each other.

The invention therefore provides a two-layer transaction system consisting of a direct transaction layer for directly exchanging tokens and a register layer. In the register layer, no transactions are logged, but only token references are stored and modifications to tokens are stored via appropriately adapted token references for the purpose of verifying the validity of tokens. This ensures the anonymity of the participants in the transaction system.

The storage unit of the token reference register preferably stores only token references of tokens valid in the transaction system. As soon as a token is modified and a corresponding (modified) token reference is intended to be registered, the (old) token references become invalid and (only) the modified token references are stored in the storage unit.

Old (i.e. invalidated) token references are deleted from the storage unit in one configuration and are archived in a (token reference) archive. The token reference archive can be part of the archiving unit, but can also be provided as a separate unit in the token reference register or in the transaction system. The token reference archive can also be completely replaced by the archiving unit if all registration requests are fully stored there. Deleting registration requests in a time-dependent manner can also apply to deleting old token references.

According to the invention, a transaction unit, preferably a secure element, is in a secure electronic transaction system having: an interface configured to: transfer tokens to another transaction unit; create and send, to a token reference register, a validity request for checking a token according to one of the configurations above; a means for accessing a token store, or a token store, wherein the token store stores at least one token of the transaction unit with a modification statement; and a computing unit configured to: apply a one-way cryptographic function to a private part of a token-specific key pair of a token in the token store in order to obtain a token reference; and modify tokens.

In addition, the transaction unit has means for accessing a token store and/or the transaction unit has a token store, wherein the token store stores at least one token of the transaction unit with the sequence of registration requests.

In addition, the transaction unit has a computing unit configured to apply a one-way cryptographic function to a private part of a token-specific key pair of a token in the token store in order to obtain a token reference; and to modify tokens. Modifying tokens comprises, in particular, splitting tokens, merging tokens, and/or switching tokens in the manner described above.

The transaction unit can be configured in such a way that only one token is stored in its token store. This token is split for direct transactions (SPLIT) in order to generate a correct token value corresponding to the transaction to be made. When tokens are received in the transaction unit, the received token is immediately merged with the token in the token store (MERGE).

In order to transfer a token to another transaction unit, this token in the token store can thus be split (SPLIT), in which case a registration request is generated for this purpose. Preferably, the registration request has a token reference of the token to be split and a token reference of the split tokens in each case.

When a token is received from another transaction unit, the received token is merged with the token in the token store, in which case a registration request is generated for this purpose. Preferably, the registration request has a token reference of the merged token and a token reference of the tokens to be merged in each case.

In the present case, a transaction unit can be a secure element that has secure access to tokens in a token store. The secure element is inserted into a terminal such that it is ready for operation, for example. The secure element and/or the terminal has/have a special computer program product (electronic wallet), in particular in the form of a secured runtime environment within an operating system of a terminal, known as a Trusted Execution Environment, TEE, stored in a data store, for example of a mobile terminal or a machine, preferably an ATM. Alternatively, the secure element is designed, for example, as special hardware, in particular in the form of a secured hardware platform module, known as a Trusted Platform Module TPM, or as an embedded security module, eUICC, eSIM. The secure element provides a trusted environment.

Communication between two transaction units for the purpose of exchanging tokens can take place in a wireless or wired manner, or, for example, also optically, preferably via a QR code or barcode, and can be designed as a secure channel. The exchange of tokens is additionally secured for transport, for example, by cryptographic keys, for example a session key negotiated for token exchange, or on the basis of a transaction unit-specific key pair.

The invention and further embodiments and advantages of the invention are explained in more detail below with reference to figures, wherein the figures merely describe exemplary embodiments of the invention. The same components in the figures are provided with the same reference signs. The figures should not be considered to be true to scale; individual elements of the figures may be illustrated so as to be overly large or overly simplified.

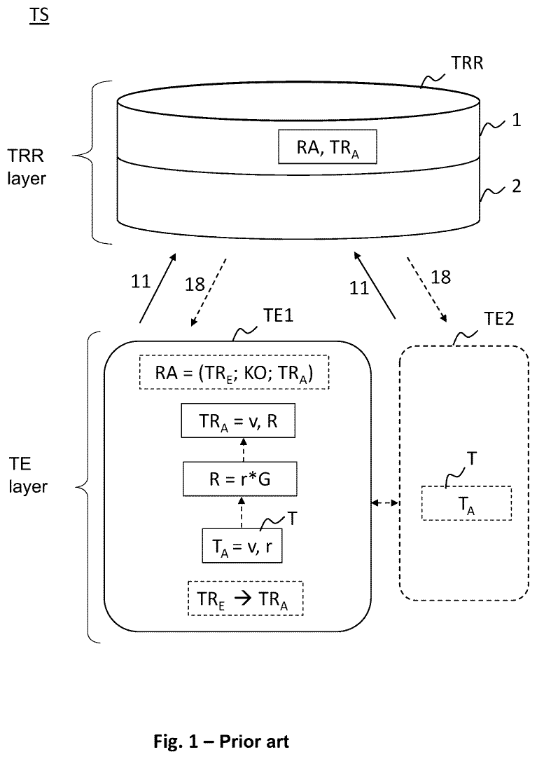

FIG. 1 shows an exemplary embodiment of a transaction system according to the prior art;

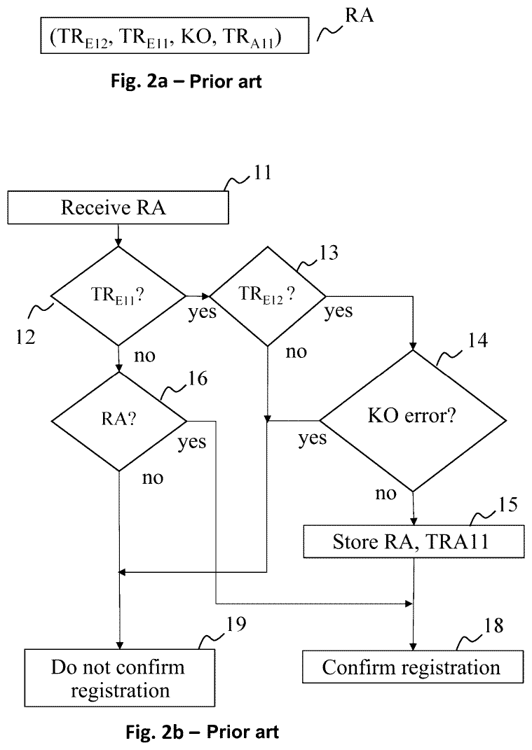

FIG. 2a shows a registration request according to the prior art;

FIG. 2b shows a registration procedure for a registration request according to FIG. 2a according to the prior art;

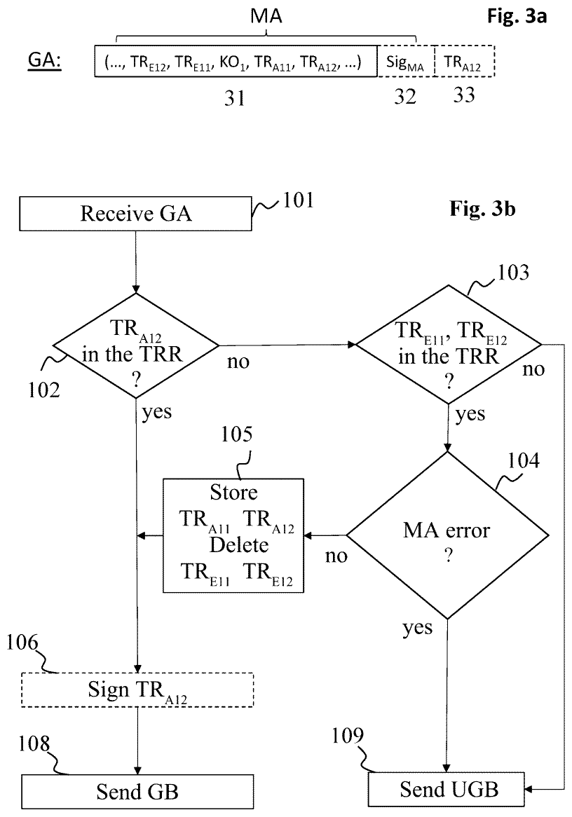

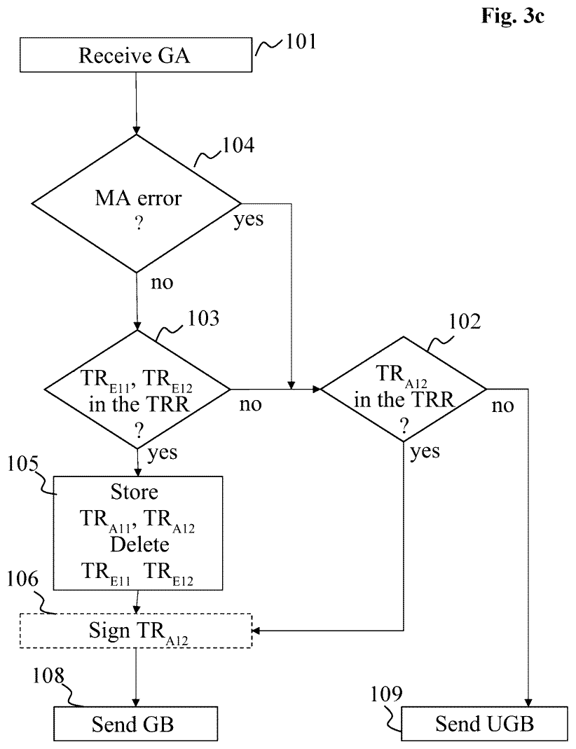

FIG. 3a shows a first exemplary embodiment of a validity request according to the invention;

FIG. 3b shows a first exemplary embodiment of a method for checking the validity of a token based on a validity request according to FIG. 3a according to the invention;

FIG. 3c shows a second exemplary embodiment of a method for checking the validity of a token based on a validity request according to FIG. 3a according to the invention;

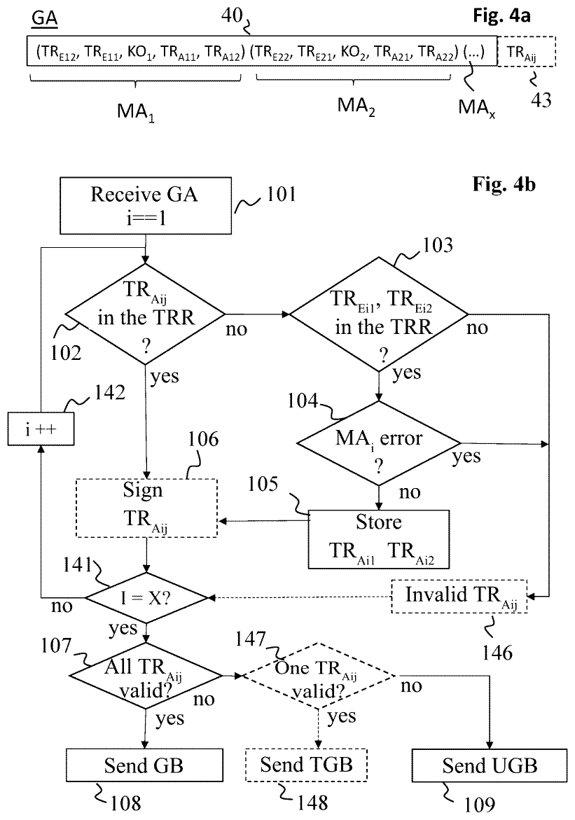

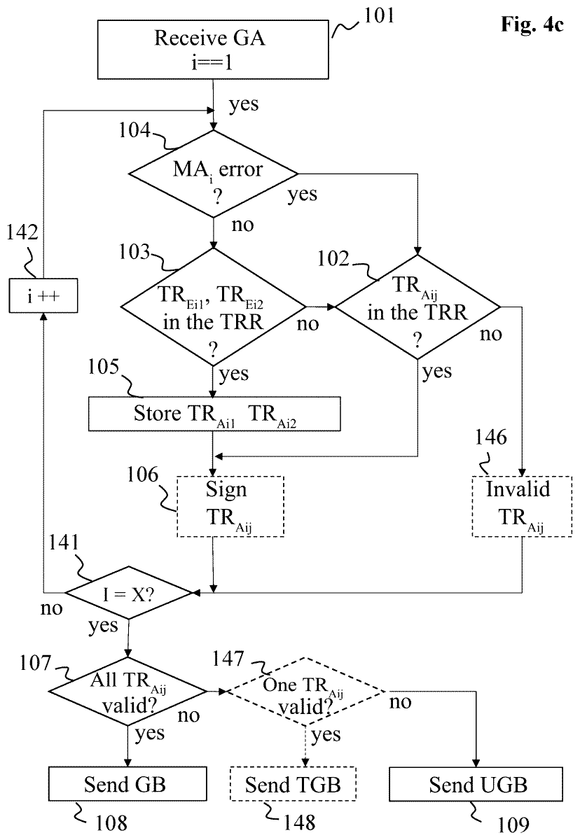

FIG. 4a shows a second exemplary embodiment of a validity request according to the invention;

FIG. 4b shows a first exemplary embodiment of a method for checking the validity of a token based on a validity request according to FIG. 4a according to the invention;

FIG. 4c shows a second exemplary embodiment of a method for checking the validity of a token based on a validity request according to FIG. 4a according to the invention;

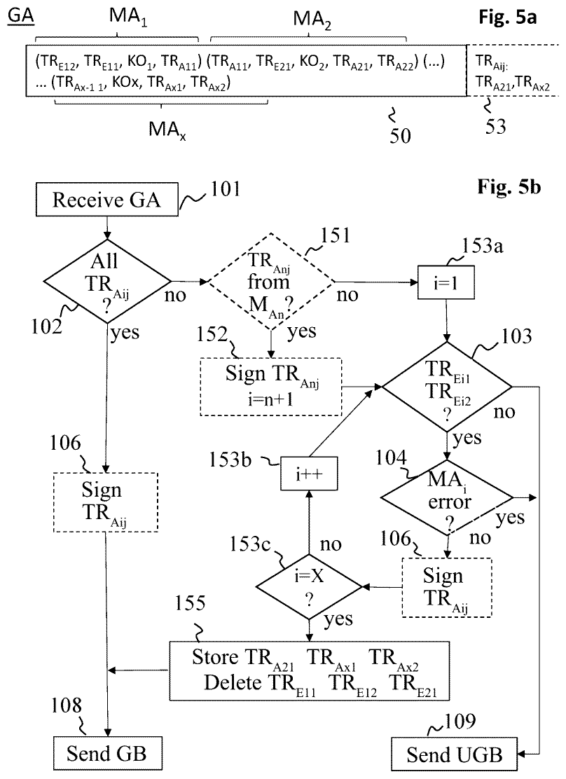

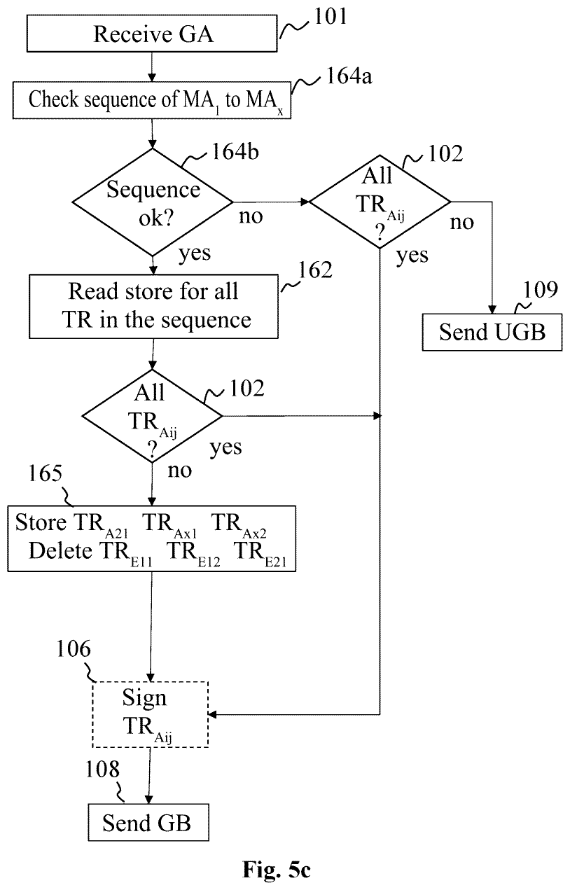

FIG. 5a shows a third exemplary embodiment of a validity request according to the invention;

FIG. 5b shows a first exemplary embodiment of a method for checking the validity of a token based on a validity request according to FIG. 5a according to the invention;

FIG. 5c shows a second exemplary embodiment of a method for checking the validity of a token based on a validity request according to FIG. 5a according to the invention;

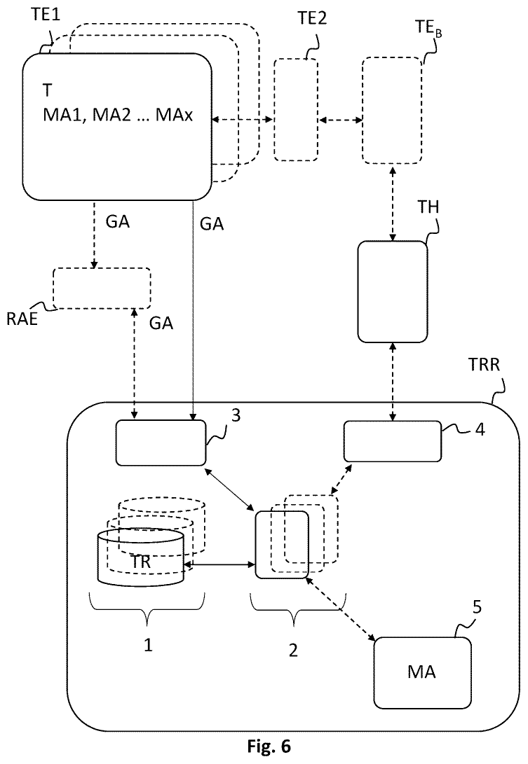

FIG. 6 shows a further exemplary embodiment of a transaction system having a token reference register according to the invention.

FIG. 1 shows an exemplary embodiment of a transaction system TS according to the prior art. The transaction system TS comprises a register layer TRR layer in which a token reference register TRR is arranged. The transaction system also comprises a direct transaction layer TE layer in which a multiplicity of transaction units (or subscriber units) TE can be provided; two transaction units TE1, TE2 are shown in a representative manner. The transaction units TE1, TE2 are preferably secure elements.

The transaction units TE of the transaction system TS are configured to exchange tokens T directly with each other. In the case of FIG. 1, the tokens are payment tokens which are also referred to as a digital coin. Each token T is generated by a token issuer TH (not shown in FIG. 1). Each token T can be modified, i.e. split, merged or switched, by any transaction unit TE and can be generated and also deleted by the token issuer TH. For example, a token issuer TH is a central bank.

A token T is uniquely represented in the transaction system TS by a token value v and a random number r as token elements. The token value v can be specified in a value range from 1 to 2³¹−1. The random number r can be a number in the range from 0 to 2²⁵⁶−1, that is to say the order of an elliptical curve, for example secp256r1.

The random number r is a private part of a token-specific key pair. The random number r is unique and secret in the transaction system TS and must not be published or reused. The generation of the random number r must be unpredictable.

By way of example, the token value v is a 32-bit token element of the integer type. By way of example, the random number r is a 32-byte token element of the integer type. A transaction unit TE has exclusive access to this token store or includes this token store in a data store of the transaction unit TE.

For each token T, a token reference TR can be stored in the token reference register TRR. The token reference TR comprises the token value v of the assigned token T and a public part R of the token-specific key pair. The token value v of a token T is thus known in the token reference register TRR.

The public part R of the token-specific key pair is generated by applying a cryptographic function to the private part r of the token-specific key pair. This function is difficult to reverse and thus gives the transaction system TS the required security. R=r*G, where G may be, for example, a global parameter of the transaction system TS, for example a generator point of an elliptical curve, in this case the secp256r1 curve.

The token reference TR is then formed by the token value v of the token and the public part R of the key pair. The token reference TR is thus the concatenation of the token value v and the public part R.

A token reference TR can be sent to the token reference register TRR together with a modification statement (see overview in FIGS. 6a and 6b) as a registration request RA with respect to the token T. The modified token T is registered with its token reference in the token reference register TRR. In FIG. 1, the transaction unit TE1 generates a new token T_{A}, the token reference TR_{A} of which is intended to be stored with the same token value v in the token reference register TRR instead of the token reference TR_{E} of the old token T_{E}. The transaction unit TE1 and/or—after the token T_{A} with its modification statement has been transferred to the transaction unit TE2—the transaction unit TE2 can send the registration request.

FIG. 1 initially illustrates a known token reference register TRR.

The token reference register TRR manages in particular the storage location for the token references TR, which can optionally also store the previous registration requests RA, illustrated here as a database 1 as an example of a storage unit in the token reference register TRR. This is represented by the token reference TR for the token T of the transaction unit TE1 being entered in the database 1. This database 1 can consist of a combination of many databases (see also FIG. 6) which are networked to each other.

Moreover, the token reference register TRR comprises at least one verification unit 2. The verification unit 2 of the token reference register TRR verifies registration requests RA. In this case, syntactic correctness or else the correct specification of a command in the registration request RA can be verified. The history from old (past) registration requests RA can also be checked. The separation of this verification unit 2 from the database 1 distributes the tasks of storing and checking and increases the speed in the token reference register TRR.

FIG. 1 likewise already indicates that the token reference register TRR of transaction units TE receives 11 registration requests RA and possibly sends 18 a registration confirmation RB to the transaction unit.

FIG. 2a illustrates an example of a registration request RA according to the prior art. The registration request in FIG. 2a comprises two input token references TR_{E}, an output token reference TR_{A} and a modification command KO.

In addition, the registration request RA may be signed with the private part r of the token-specific key pair (not illustrated). The signing makes it possible to verify whether the sender of the token reference TR_{E} was in possession of the input token T_{E}, thus further increasing the security in the transaction system TS.

FIG. 2b illustrates a method sequence for registering a token according to the prior art. In step 11, the registration request is received in the token reference register. Step 12 checks whether an input token reference TR_{E11} of the registration request is stored in the token reference register.

In the case of a no in step 12, step 16 also checks whether the registration request RA has already been executed and is stored as part of the registration request history in the storage unit 1. In the case of a YES, the registration is confirmed 18 (again). In the case of a no in step 16, the registration request is not confirmed according to step 19 (error message).

In the case of a yes in step 12, step 13 is carried out. Step 13 checks whether an input token reference TR_{E12} of the registration request is stored in the token reference register.

In the case of a yes in step 13, step 14 is carried out. Step 14 checks whether the command with the input token references TR_{E12} and TR_{E11} leads to the output token reference TR_{A11} of the registration request, that is to say, for example, ν_{E11}+ν_{E12}=ν_{A11} and the signatures are valid. In step 14, the command is correspondingly checked for errors.

In the case of a no in step 13 or in the case of a yes in step 14, the registration request is not confirmed according to step 19 (error message). In the case of a no in step 14, the TR_{A11} of the registration request and the registration request are stored in the token reference register in step 15. Step 18 is used to confirm to the transaction unit that the registration has been carried out.

The token reference register TRR preferably cannot be read by the transaction units TE1, TE2. It is not very practical but theoretically known that a transaction unit can query the status of a token, i.e. can query the status with which a token reference TR is stored in the token reference register TRR. However, such a status query is not a validity request in the present sense, as is now described in more detail.

A transaction unit TE1, TE2 can send one or more existing modification statements MA, each of which links one (or more) output token(s) to one (or more) input token(s) via a command, as a validity request to the token reference register. Especially for security elements as a transaction unit, the resulting relief of its limited resources is helpful. Especially in security elements, there may be a plurality of modification statements for different tokens (stack of modification statements) and/or for one token (sequence of modification statements).

The transaction unit TE1, TE2 sends the modification statement(s) in a validity request for at least one token reference and receives a validity confirmation from the token reference register TRR for the at least one requested token reference. The validity request comprises a plurality of output token references. The token reference register TRR can provide a signature for each requested token reference in the validity confirmation.

The token reference register TRR shown in FIG. 1 is now also configured to verify validity requests GA. The verification unit 2 of the token reference register, for example, is provided for this purpose. The verification unit 2 of the token reference register TRR then verifies registration requests RA and/or validity requests GA.

A history of old (past) validity requests GA with respect to a token T can also be verified in this case. However, the history is not needed to process validity requests GA. In this respect, the storage unit 1 of the token reference register can advantageously contain only the valid token references TR. A history of previously valid token references TR and/or modification statements that have already been executed can be provided in a separate unit, an archive unit. It is sometimes stated below for short that it is checked whether a token reference is stored in the token reference register, but it is checked in each case whether the token reference is stored as a valid token reference or, assuming that the storage unit 1 contains only the valid token references, whether it is stored in the storage unit 1.

FIG. 3a shows a first exemplary embodiment of a validity request GA according to the invention. The validity request in FIG. 3a comprises a (single) modification statement MA. This modification statement comprises input token references TR_{E11}, TR_{E12} and output token references TR_{A11}, TR_{A12} and a modification command KO. The number of output token references TR_{A} and the number of input token references TR_{E} in the modification request MA is not limiting, and it can be more (indicated by the dots) or even less. Examples of the number of input and output token references TR per specific modification command KO will be given later.

The modification statement MA can optionally comprise one or more signatures 32. In addition to the detailed data 31 relating to the modification, the modification statement MA comprises a signature of the modification statement. A signature 32 is preferably created with the private part r of an input token reference; in particular, for each input token reference TR_{E11}, TR_{E12} of the modification request MA, there may be a signature 32 with the associated private part r_{E11}, r_{E12}.

The validity request GA can optionally comprise a checking statement 33. The checking statement indicates the one or more output token reference(s) to be checked for validity. In the example shown, the validity of the output token reference TR_{A12} therefore needs to be checked. For example, for a validity request GA without an explicit checking statement 33, all output token references can be checked for validity. The modification statement of the validity request comprises at least one output token reference TR_{A12} to be checked for validity and preferably one (or more) output token reference(s) TR_{A11} not to be checked for validity.

FIG. 3b shows a first exemplary embodiment of a method for checking the validity of a token T based on a validity request GA, for example according to FIG. 3a, according to the invention. In step 101, the token reference register receives the validity request and optionally checks the modification statement of the validity request in further steps 103-105.

In step 102, the token reference register checks whether the TR_{A12} of the modification statement is stored as a valid token reference in the token reference register (in particular in its storage unit 1). TR_{A12} is the output token reference included in the checking statement 33 of the validity request. In the case of a yes in step 102, a validity confirmation GB is sent to the transaction unit in step 108 in response to the validity request. In contrast, the modification statement of the validity request is not checked further. An output token reference of the modification statement already exists in the token reference register. The token reference register must have already executed the modification statement in the past.

Optionally, at least one signature of the token reference register is created in a step 106, in particular a signature of the token reference register for the valid output token reference(s) TR_{A12}. The validity confirmation GB may contain or be formed by the signature of the token reference register for the valid output token reference(s).

In the case of a no in step 102, the token reference register checks (verifies) the modification statements 103, 104 and executes 105 them, if necessary. In step 103, the token reference register checks whether each input token reference TR_{E11} and TR_{E12} of the modification statement is stored in the token reference register. If the input token references TR_{E11} and TR_{E12} of the modification statement are stored in the token reference register (yes), the token reference register checks the modification statement for errors 104. For example, the syntax of the modification statement is checked, that is to say in particular the command KO (e.g.: unknown command type or command type of the token issuer) and/or the number of input and output token references (e.g.: no or too few output token references/input token references). The value neutrality of the token reference values (sum of input value(s)=sum of output value(s)) and/or the signature(s) 32 of the modification statement is/are checked.

If the verification 103, 104 of the modification statement is not successful, an invalidity confirmation UGB is sent 109 for the validity request. In contrast to handling the modification statement as a registration request, the history is thus no longer used to check whether the modification statement has already been executed. Both in the case of a no in step 103 and in the case of an error in the modification statement (case of a yes in step 104), the invalidity confirmation is sent in step 109.

If the verification 103, 104 of the modification statement is successful, the token reference register executes 105 the modification statement and sends the validity confirmation GB for the validity request in step 108. In step 105, the token reference register deletes the input token reference(s) TR_{E11} and TR_{E12} and stores the output token reference(s) TR_{A11} and TR_{A12} of the modification statement in the token reference register or in the storage unit 1 of the token reference register. Step 106 is in turn optionally carried out before step 108, that is to say only TR_{A12} is signed in the present example and the signature for TR_{A12} is provided in the validity confirmation for the validity request in the token reference register of the transaction unit TE.

With the method according to FIG. 3b, it is first checked whether the (indicated) TR_{A} of the validity request is (are) stored in the token reference register as valid token reference(s) and TR_{E} and the command are checked (i.e. the modification statement is verified) only if the TR_{A} in the token reference register are not valid. This reduces the effort involved in checking the validity. In addition, a history is no longer checked for the modification statement either, since the modification statement was received in a validity request GA.

FIG. 3c shows a second exemplary embodiment of a method sequence for checking the validity of a token T based on a validity request GA according to FIG. 3a according to the invention.

In step 101, the token reference register receives the validity request and then first checks 104 the modification statement of the validity request for errors (in particular in terms of syntax, value neutrality and/or signatures). In step 103, if the modification statement itself is error-free, the token reference register checks whether the input token reference(s) TR_{E11} and TR_{E12} of the modification statement is/are stored in the token reference register. If the input token references TR_{E11} and TR_{E12} are stored in the token reference register (yes), the modification statement of the validity request is executed 105.

If, on the other hand, the modification statement is erroneous (case of a yes in step 104) or if the input token reference(s) of the modification statement is/are not stored in the token reference register (case of a no in step 103), step 102 is executed. In particular, if the modification statement cannot be verified, step 102 checks whether the (optionally indicated) output token reference TR_{A12} or the (optionally indicated) output token references is/are stored in the storage unit 1 of the token reference register.

In the case of a yes in step 102, a validity confirmation GB is sent to the transaction unit in step 108 in response to the validity request. The (indicated) output token reference(s) is (are) already stored in the token reference register, in particular in its storage unit 1. The token reference register has already executed the modification statement with this TR_{A} in the past. Optionally, a signature of the token reference register is created 106 beforehand for the (indicated) output token reference(s), that is to say in this case TRA12. In the case of a no in step 102, on the other hand, the token reference register sends 109 an invalidity confirmation UGB for the (indicated) output token reference(s) of the modification statement.

In the case of a yes in step 103, the token reference register executes the modification command KO of the modification statement in step 105 and then sends 108 the validity confirmation. In the token reference register, the input token references of the modification statement are deleted and the output token references of the modification statement are stored in step 105.

With the method according to FIG. 3c, it is first checked whether the modification statement is erroneous and/or the TR_{E} are not stored in the token reference register. Otherwise, that is to say even though the modification statement of the validity request cannot be executed, it is checked whether the (indicated) TR_{A} of the validity request are already stored.

The method according to FIG. 3c also reduces the effort involved in checking the validity.

FIG. 4a shows a second exemplary embodiment of a validity request GA according to the invention. This validity request comprises two or more modification requests MA (MA₁, MA₂, . . . MAₓ). Each modification statement comprises (one or) more input token references TR_{E11}, TR_{E12} and (one or) more output token references TR_{A11} TR_{A12} and a modification command KO. The number of output token references TR_{A} and the number of input token references TR_{E} in the modification request MA is not limiting, and it can be more or even less. Examples of the typical number of input and output token references TR per specific command KO will be listed later. Optional signatures of the modification statement are not illustrated separately here.

The modification statements of the validity request are individually verified. The most recent modification statement, Max, is preferably verified first. In general, modification statements of the validity request are optionally verified until either a validity confirmation or an invalidity confirmation can be sent for the validity request. On a case-by-case basis, all modification statements of the validity request can be checked and executed in succession before a validity confirmation is sent. However, a validity confirmation for the validity request can already be sent on a case-by-case basis even without checking a single modification statement (according to FIG. 4b, for example in the special case: TR_{Aij}=TR_{A1j}).

The modification requests MA of the validity request can be in the form of a stack or a sequence of modification requests MA.

In the case of a sequence of modification statements, the modification statements will indicate substantially temporally successive modifications to tokens. At least one output token reference of a modification statement in the sequence will be an input token reference of another modification statement in the sequence. Preferably, two or more successive modification statements, for example MAx₋₁ and MAₓ, of the validity request have an input token reference that is the output token reference of a previous modification statement of the validity request. Accordingly, the modification requests MA of the validity request must be executed in the order MA₁ . . . MAₓ in which they are present in the validity request. MAₓ is the most recent modification statement and represents the last modification to a token.

However, FIG. 4a shows, as an example, a stack of modification statements in the validity request. The input and output token references TR of the modification requests MA in the validity request are essentially independent of each other (neither TR_{A11} nor TR_{A12} corresponds, for example, to TR_{E21} or TR_{E12}). Especially for larger stacks (with for example i>5) and/or for stacks with modification statements of only one transaction unit, it may nevertheless occur that an output token reference of a modification statement in the stack is an input token reference of another modification statement in the stack.

As an optional checking statement 43, the validity request 40 shown comprises one or more output token references TR_{Aij} (jth output token reference of the i-th modification statement) to be checked for validity. The indicated output token reference(s) TR_{Aij} may comprise one, more or no output token reference of the last modification statement (MAₓ) of the validity request, even in the case of a sequence. In particular, the checking statement may comprise two or more output token references TR_{Aij} of the validity request from different modification statements, such as TR_{A21} and TR_{Ax1}. Furthermore, the checking statement may not comprise two or more output token references TR_{Aij} of the validity request, preferably from different modification statements, such as TR_{A11}, TR_{A22} and/or TR_{Ax2}.

FIG. 4b shows a first exemplary embodiment of a method for checking the validity of at least one token T based on a validity request GA with a plurality of modification statements, for example according to FIG. 4a. The sequence of the method in FIG. 4b essentially corresponds to the method according to FIG. 3b (identical steps 102, 103, 104, 105, 106) and, in this regard, reference is made to the comments in FIG. 3b.

The method according to FIG. 4b comprises a loop 141, 142 for the modification requests MA of the validity request (with loop index i=1 to x for MAᵢ). Starting with the first modification statement of the validity request, MA₁, it is checked 102 whether an indicated output token reference, TR_{A1j}, or alternatively all output token references of the modification statement, TR_{A11} and TR_{A11}, of the modification statement are already stored (as valid token references). If necessary, the modification request MAᵢ is executed 105. In a variant of the method that is not illustrated, an invalidity confirmation could be sent in step 109 as soon as the current modification statement of the validity request cannot be executed (case of a no in step 103 or case of a yes in step 104), if all token references of the validity request need to be checked for validity. In the example shown in FIG. 4b, on the other hand, the loop 141, 142, including steps 102-106 (and 146), is run through for each modification statement, MA₁ . . . MAₓ, of the validity request.

According to step 102, output token references TR_{Aij} already previously stored or stored in step 105 can be buffered in the loop as TR_{A} of the validity request, which are recognized as valid or have already been signed. Step 146 also optionally buffers the fact that the indicated TR_{A1j} of MAᵢ or the output token reference(s), TR_{A1j}, of MAᵢ is/are invalid.

If all indicated TR_{Aij} are valid or all output token references of the validity request are valid, a validity confirmation GB for the validity request, including optional signatures, will be sent 108. Otherwise, an invalidity confirmation can be sent 109. Optionally, a partial validity confirmation TGB can be (created and) sent 148, provided that not all but at least one questionable output token reference is valid (step 147). The partial validity confirmation TGB preferably comprises only the signatures of the token reference register for the valid output token references of the validity request or the valid output token references TR_{Aij} to be checked for validity.

Step 141 checks whether the current modification statement MAᵢ is the last modification statement of the validity request (i.e. whether I==X). Alternatively or additionally, it can be checked whether all indicated TR_{Aij} have already been recognized as valid and/or invalid. In the case of a no in step 141, the next modification statement of the validity request is verified, indicated by step 142, which increments the running index “i” (the index i is i=1 at the start in step 101). The next modification statement is then checked in steps 102-106, 146 again. If a termination criterion of the loop is detected (case of a yes in 141), the validity confirmation GB for the validity request is sent to the transaction unit in a case-dependent manner (steps 107, 147) or the invalidity confirmation UGB for the validity request is sent (or optionally a partial validity confirmation for the validity request is sent).

FIG. 4c shows a further exemplary embodiment of a method for checking the validity of a token T based on a validity request GA with a plurality of modification statements, in particular according to FIG. 4a. The sequence of the method in FIG. 4c essentially corresponds to the method according to FIG. 3c (identical steps or sequence of steps 104, 103, 102, 105, 106) and, in this regard, reference is made to the comments in FIG. 3c.

The method according to FIG. 4c also comprises a loop 141, 142 with a termination criterion (all indicated TR_{Aij} checked for validity or all modification statements run through), which allows each modification statement of the validity request to run through the sequence of steps 102-106, 146 until the termination criterion is reached. As before, the corresponding confirmation GB/UGB/TGB is then sent 108/109/149 in a case-dependent manner. Even in a sequence according to FIG. 4c, modification statements of the validity request may remain unchecked and a validity confirmation GB for the TR_{Aij} to be checked for validity can still be sent.

Stacks of modification statements MA are preferably checked using the method according to FIGS. 4b and 4c. The modification statements contain mutually independent token references.

FIG. 5a shows a third exemplary embodiment of a validity request GA according to the invention. The validity request comprises a plurality of modification statements MA₁, MA₂, . . . MAₓ. The modification statements of the validity request depend on each other. In this respect, the validity request comprises a series of modification statements, some of which have also already been described in more detail above.

In the example shown, the output token reference TR_{A11} of MA₁ is an input token reference of MA₂. The output token reference TR_{A22} of MA₂ could be an input token reference of another modification statement of the validity request, for example MA₃, MA₄ or MAₓ. The first input token reference of MAₓ is the output token reference TR_{Ax-1 1} of MAₓ₋₁. As the output token references TR_{Aij} of the validity request that are to be checked for validity, the checking statement 53 of the validity request contains the output token references TR_{A21} and TR_{Ax2}. The optional signatures of the modification statement are in turn not illustrated in the figure.

FIG. 5b shows a first exemplary embodiment of a method for checking the validity of a token T based on a validity request GA with a plurality of, preferably interdependent, modification statements—in particular according to FIG. 5a.

The validity request is received 101 and step 102 checks whether the token references TR_{Aij} to be checked for validity are stored as valid token references in the token reference register, that is to say in particular whether they are present in the storage unit 1 of the token reference register which contains only the valid token references. If the indicated output token references TR_{A21} and TR_{Ax2} are already stored, the validity confirmation GB can be sent 108—optionally after the signatures have been created 106 as cryptographic confirmation of the token reference register for the valid token references. In this case, none of the modification statements of the validity request are checked (for errors and/or feasibility).

In a loop 153a-c, the x modification statements MA in the sequence are checked 103, 104 in succession. For the respective MAᵢ, step 103 checks whether the input token reference(s) TR_{Ei1} and TR_{Ei2} is/are stored in the storage unit 1 of the token reference register, i.e. is/are valid. In the case of a no, an invalidity confirmation UGB is sent 109. Likewise, in the case (of a yes) in step 104 indicating that a check of the MAᵢ reveals an error (as before: syntax, value neutrality, . . . ).

However, in the case of a no in step 104, since the method is oriented to a sequence whose token references depend on each other, the modification statement is not yet actually executed. The output token references TR_{A} of the MAᵢ are not yet stored. It would be conceivable to delete the input token references TR_{E} of the MAᵢ in the loop, but it is also preferable to do so only in step 155. The verification unit 2 only buffers the output token references TR_{A} of the MAᵢ that are to be stored (and the input token references TR_{E} of the MAᵢ that are to be deleted). A plurality of these buffered output token references will be the input token reference of a further modification statement of the validity request (that is to say would therefore need to be deleted again). Now they are simply removed from the buffer of the verification unit. Unnecessary write access (or a plurality of unnecessary write or delete accesses) to the storage unit 1 can thus be avoided. It is not until step 155 that the buffered output token references (that are not deleted there again) are written to the storage unit. Step 155 can also be referred to as selective storage of all of the output token references in the sequence. In the example in FIG. 5b, the output token references TR_{A21} TR_{Ax1} TR_{Ax2} are stored and the input token references TR_{E11} TR_{E12} TR_{E21} are deleted. It is then possible to send the validity confirmation for the output token references TR_{A21}, TR_{Ax2}.

FIG. 5b uses steps 151, 152 to show optional steps that would prevent already executed modification statements MA in the sequence of modification statements of the validity request erroneously leading to an invalidity confirmation UGB. If it is determined in step 102 or 151 that a TR_{Anj} is already stored, this token reference is signed and the index of the loop is set to i=n+1 in step 152. The modification statement MAₙ has already been executed. The processing of the sequence of modification statements can therefore be started with the subsequent modification statement MAₙ₊₁ in the sequence. In configurations that are not illustrated, the sequence of modification statements can be evaluated in order to recognize side branches of the sequence and to take them into account as such in the processing of the sequence.

FIG. 5c shows a further exemplary embodiment of a method for checking the validity of a token T based on a validity request GA with a plurality of modification statements, in particular according to FIG. 5a, or a validity request with a sequence of modification statements.

For the validity request received in step 101, all modification statements MA₁ to MAₓ of the validity request are first checked for errors in step 164a. If the modification statements contain an error (case of a no in step 164b), a check is carried out in order to determine whether the indicated output token references TR_{Aij} of the validity request are all already stored 102. Depending on the case, the invalidity confirmation is accordingly sent 109 or—after optionally signing 106 the TR_{Aij}—the validity confirmation GB is sent 108.

In the case of a yes in step 164b, all token references of the validity request are read 162 from the storage unit 1 (a check is carried out for all token references in order to determine whether they are already stored). If all of the indicated output token references TR_{Aij} are present 102, the validity confirmation is sent 108 as before. If not (case of a no in step 162), step 165 selectively stores all of the output token references of the sequence and deletes the input token references (if still stored).

The procedure according to FIG. 5c also leads to optimized processing of the validity request with a sequence (or a stack).

After checking the validity request in FIGS. 3a to 5c or the registration request according to FIGS. 2a/b, the checked (verified) token references TR are stored in the token reference register TRR, whereby the modification to the token T is registered in the transaction system TS.

The token reference TR is uniquely assigned to the token T and serves for registering the token T in the transaction system TS. The token reference TR is therefore the public representation of the token T from the direct transaction layer TE layer. The sole knowledge or only the possession of the token reference TR does not allow the token T to be transferred and is not synonymous with the transaction unit being in possession of the token T. The token reference TR is used to prevent multiple output attempts. A check is carried out in order to determine whether token values v have been generated in an impermissible manner. Therefore, the token reference TR and possibly the history of the tokens T and corresponding modifications due to registration requests RA sent by transaction units TE are stored in the token reference register TRR.

The tokens T are stored, for example, in token stores or electronic wallets of a transaction unit. A wallet is, for example, a software application within a transaction unit TE (in particular a secure element) or a terminal into which the transaction unit is inserted such that it is ready for operation. A wallet can be configured as an application on a smartphone, a smart card or a payment terminal. The wallet serves to securely manage tokens T of the transaction unit, to generate token references TR, to modify tokens T, to exchange tokens T and/or to initiate the check of the validity of tokens. Wallets serve to communicate with the token reference register TRR, to generate registration requests RA relating to modifications of the token T for the token reference register TRR, to perform a transaction of tokens T with respect to a transaction unit TE and/or to generate validity requests GA.

For a transaction with a transaction unit TE, it is not necessary for there to be a communication connection to the token reference register TRR of the transaction system TS. The transaction system TS is configured to perform a transaction offline, that is to say without a communication connection to the token reference register TRR. A corresponding registration of tokens T can therefore temporally follow a transfer of the token T to a transaction unit TE.

The token reference register TRR is a unit of the transaction system TS and is either a central register or a central database of the transaction system TS or a decentralized register or a decentralized database (DLT) of the transaction system TS.

The invention provides for the validity of a token T to be able to be easily checked. For this purpose, a validity request GA is created by the transaction unit TE. The validity request GA comprises the token reference TR of the token T whose validity is intended to be checked. The validity request GA also comprises a modification statement relating to one or more modifications to the token T.

A token reference TR can be sent to the token reference register TRR together with a modification statement as a validity request GA with respect to the token T.

In addition—as indicated in FIG. 1—the validity request GA can be signed with the private part r of the token-specific key pair. The signing makes it possible to verify whether the sender of the token reference TR was in possession of the token T, thus further increasing the security in the transaction system TS.

A validity request GA can be sent to the token reference register TRR in order to check whether the token T is valid. This validity request GA is received in the token reference register TRR. After the validity request GA has been checked by the token reference register TRR (or its verification unit 2), the transaction unit TE is informed whether the token T is valid or not.

A validity request GA is preferably signed with the private part r. The signature allows the receiver (token reference register or transaction unit) to easily check syntactic authenticity of the command. This check is preferably carried out in the database 1 or the verification unit 2. Moreover, a validity request GA can be validated syntactically, for example, by checking the signature and/or the token reference TR.

Even if a signature can be checked in a transaction unit TE, this does not ensure that multiple output of the same token T has not been attempted. Therefore, the registration in the token reference register TRR is provided. In addition, the transaction units TE provide a secure hardware platform. With an available connection to the token reference register TRR, the token references TR are transferred, and the multiple output attempt can be discovered in the token reference register TRR.

If a token reference TR is not yet known in the token reference register TRR, it is added (stored).

In addition, an archiving unit (not illustrated in FIG. 1) can also be provided in the token reference register TRR. This archiving unit stores registration requests RA and/or validity requests and/or token references that are no longer valid.

For example, the following modifications to an existing token T may be available as commands KO: for example “Switch”, “Split” or “Merge”. Commands KO, which are reserved for the token issuer, can also concern the generation (=Create) of a token T or the deletion (Destroy) of an existing token T. In theory, another command type for checking the validity of an unmodified token T was furthermore also known in the token reference register. The following table indicates, by way of example, command encodings (0x01 to 0x05). The coding shown here and also the order of data elements in the modification statement, used in the figures, are interchangeable or only exemplary.

| Command | | Command |
|---|---|---|
| KO | Description | code |
| CREATE | Create a new token in the transaction system | 0x01 |
| DELETE | Delete an existing token in the transaction | 0x02 |
| | system | |
| SWITCH | In an existing token, replace a private part of | 0x03 |
| | the token-specific key pair with a new private | |
| | part of the token-specific key pair | |
| SPLIT | Split one (or more) existing token(s) into two | 0x04 |
| | (or more) smaller tokens | |
| MERGE | Merge two (or more) existing tokens into one | 0x05 |
| | (or more) token(s) | |

The following table indicates examples of a conceivable signature syntax. Input tokens T and input token references TR are indicated (“used”) for each command. Output tokens T and output token references TR are indicated (“generated”) for each command.

| Command | Signature syntax |
|---|---|
| CREATE | RA_{sig}_{_{—}}_{TH} = sig (pKey_{TH}, [CREATE, TR]) |
| DELETE | RA_{sig}_{_{—}}_{TH} = sig (pKey_{TH}, [DESTROY, TR]) |
| | RA_{sig}_{_{—}}_{T} = sig (r, [DESTROY, TR]) |
| SWITCH | RA_{sig}_{_{—}}_{Ta} = sig (rₐ, [SWITCH, TRₐ R_{b}]) |
| SPLIT | RA_{sig}_{_{—}}_{Ta} = sig (rₐ, [SPLIT, TRₐ TR_{b} TR_{c}]) |
| MERGE | RA_{sig}_{_{—}}_{Ta} = sig (rₐ, [MERGE, TRₐ TR_{b} TR_{c}]) |
| | RA_{sig}_{_{—}}_{Tb} = sig (r_{b}, [MERGE, TRₐ TR_{b} TR_{c}]) |

A modification statement (for example of a registration request RA or a validity request GA) has the basic structure of the following three elements: command type, input token reference(s), output token reference(s).

Each command KO has a partially characteristic number (one or more) of input token reference(s) (“inputs”) and output token reference(s) (“outputs”). For example, switching preferably has exactly one input token reference and exactly one output token reference. Splitting has exactly one (or more) input token reference(s) and at least two (or more) output token references. Merging has at least two (or more) input token references and exactly one (or more) output token reference(s).

FIG. 6 shows a further configuration of a token reference register TRR of a transaction system TS. It is indicated here that a plurality of storage units 1 can be maintained in the token reference register TRR in order a storage of a

FIG. 6 shows a further configuration of a token reference register TRR of a transaction system TS. It is indicated here that a plurality of storage units 1 can be maintained in the token reference register TRR in order to accelerate storage of a multiplicity of token references TR. It is also indicated here that a plurality of verification units 2 can be maintained in the token reference register TRR in order to accelerate verification of validity requests GA and/or registration requests RA.

In addition, a transaction unit of a bank TE_{B} is illustrated and can serve as an interface between the transaction system TS and a book money system (lending, account management). It can allow transaction units TE to transfer tokens T of the transaction system TS to another transaction system TS. This transfer is possible bidirectionally. The token issuer TH is solely responsible for generating tokens T and also for deleting tokens T in the transaction system.

In addition, FIG. 6 shows a registration request unit RAE which can receive a validity request GA (and/or registration request) from a transaction unit TE1 and forwards the validity request (and/or registration request) to the token reference register.

The token reference register also contains an archive unit 5 which stores registration requests and/or validity requests which have already been executed and/or token references which are no longer valid, in particular as a concatenated graph.

Transaction units TE can send their registration requests and/or validity requests to the token reference register via a first interface 3 of the token reference register. In contrast, only the token issuer TH may send commands to the token reference register via the second interface 4 of the token reference register.

It may be advantageous if only one (or a few) token(s) T is (are) used per transaction unit TE (here as a secure element, for example smart card or TEE). This means that the transaction unit merges a received token T with the token T stored in the token store (MERGE). This also means that the transaction unit separates a token T to be sent from the token T stored in the token store (SPLIT). These modifications to the token T can be performed without a registration request RA or validity request GA and the token T can be forwarded immediately after a modification. Thus, there may be a sequence of modifications to the token T that are not known to the token reference register. Typically, the sequence of modification statements MA consists of a combination of SPLIT and MERGE modifications. Each of these modifications is also referred to as “proof” (see above for FIG. 1) or is stored as a, preferably signed, modification statement MA with the token T. The sequence of modification statements MA_{F} or MA₁, MA₂, . . . MAₓ is thus produced in the TE1 for the token T.

According to the invention, a validity request GA is now provided in order to check a token for validity.

The terminal receives the validity request and/or the modification statement or MA_{F} for this purpose. Alternatively or additionally, a registration request unit RAE can be also provided as a mediation instance between the transaction unit and the token reference register, see FIG. 6. The registration request unit then receives the validity request and/or the modification statement or MA_{F} from the transaction unit or the terminal. A validity request is sent to the token reference register.

The terminal (not shown in FIG. 6) or the registration request unit attempts to transmit the validity request to the token reference register. This means that the terminal or the registration request unit only performs protocol translation, for example from APDU between the terminal/registration request unit and the transaction unit to HTTP(S). The validity request and/or the modification statement or MA_{F} is/are neither evaluated nor interpreted by the terminal or the registration request unit. The order of modification statements in a validity request of a sequence MA_{F} is not changed by the terminal or the registration request unit. A validity confirmation GB (or a registration confirmation RB) of the token reference register is then transferred from the terminal and/or the registration request unit to the transaction unit. Each validity request and/or the modification statement or MA_{F} can be signed with the private part r (the random number r) of the relevant token-specific key pair. Therefore, the modification statements MA, which are stored in the transaction unit (in the token store), are sometimes also referred to as proof.

The verification unit 2 of the token reference register checks the validity, in particular using a method according to FIGS. 3b to 5c. A validity confirmation is sent back to the secure element or the transaction unit (possibly via the registration request unit or the terminal).

Assuming that a TE1 performed, for example, the following modification sequence on a token A:
Split: A→B, C (token A is split into tokens B and C)
Switch: C→D (token C was switched to token D)

Token D is transferred to TE2 with the two modifications (proofs) “Split” and “Switch”.

TE2 also performs:
Merge: D, E→F (tokens D and E are merged to form token F)

Validity check of token F: Only token F is intended to be checked for validity. For this purpose, a validity request is generated and the token reference of token F (as a checking specification) is sent from the TE2 to the token reference register as a validity request together with the modification statements MA consisting of the three modifications (proofs) “Split”, “Switch” and “Merge”. The output token reference TR_{B} of the first modification statement of the validity requests should not be checked or is not checked for validity by the token reference register according to the validity request which only indicates token F by means of its token reference as the token to be checked. In this case example, the first two modification statements of the validity request are only executed optionally, for example if TE1 (or another transaction unit) has not yet sent a registration request or a validity request with these two modification statements to the token reference register.

The token reference register can optionally return the validity confirmation in the form of a status message that also encodes additional information, for example:
200: Token is valid, all modifications of the modification statement could be resolved
400: Token is valid, some modifications of the modification statement could not be resolved
500: Internal error
600: Token is invalid.

The cryptographic confirmations, that is to say in particular signatures, of the token reference register can be attached to such a status message.

The validity confirmation or the valid token references can be signed with a private key pKey_{TRR} of a key pair of the verification unit 2.

### LIST OF REFERENCE SIGNS

PKey_{TH} Public part of the token issuer key pair
pKey_{TH} Private part of the token issuer key pair
PKey_{TRR} Public part of the verification unit key pair
pKey_{TRR} Private part of the verification unit key pair
R Public part of the token-specific key pair
r Private part of the token-specific key pair
GA Validity request
GA_{sig_T} Validity request signed with the private part of the token-specific key pair
GB Validity confirmation
UGB Invalidity confirmation
GB_{sig_TRR} Validity confirmation signed with the private part of the token reference register key pair
RA Registration request
RA_{sig_T} Registration request signed with the private part of the token-specific key pair
RA_{sig_TH} Registration request signed with the private part of the token issuer key pair
MA Modification statement
RAE Registration request unit
RB Registration response, registration confirmation
T Token
TE Transaction unit
TE_{B} Bank transaction unit
TE layer Direct transaction layer
TRR layer Register layer
TH Token issuer
TRₓ Token reference of the validity request
TR_{E} Input token reference
TR_{A} Output token reference
KO Command, modification command
TRR Token reference register
TS Transaction system
v, TW Token value
a-h Indices for various tokens and token references
Σ Total token value of the transaction system
1 Database, storage unit
2 Verification unit
11-19 Method steps in the prior art
3 Subscriber interface/modification statement receiving unit
4 Issuer interface/reregistration unit
Modification statement archiving unit
6 Total sum checking unit
30 Validity request
31 Modification statement
32 Signature of the modification statement
33,43,53 Checking statement
40 Validity request for stack of modification statements
50 Validity request for sequence of modification statements
101 Receive validity request
102 Check whether TR_{A} is stored
103 Check whether TR_{E} is stored
104 Check modification statement for errors
105 Store TR_{A}
106 Create signature
108 Send validity confirmation
109 Send an invalidity confirmation
141,142 Processing loop for MAᵢ
146 Note invalidity for TR_{A}
107 Check whether overall validity has been determined
147 Check whether partial validity has been determined
148 Send partial validity confirmation
151 Check whether a TR_{An} is stored
152 Sign the TR_{An}
153a,153b, 153c Processing loop for MAᵢ
155 Selectively store the modification statement sequence for TR_{A}
164a Verify the modification statement sequence
164b Check whether the sequence is verified
165 Selectively store the modification statement sequence for TR_{A}

1.-17. (canceled)

18. A secure element of an electronic transaction system, wherein the secure element has a token store for tokens of the transaction system;
wherein the secure element is configured as a transaction unit in order to exchange tokens of the transaction system directly with another transaction unit of the transaction system;
wherein each token of the transaction system is uniquely assigned a token reference which can be registered in a token reference register of the transaction system;
wherein the secure element is configured to generate at least one output token and its output token reference from at least one input token;
wherein the secure element provides at least one modification statement, which comprises at least one input token reference, a command and at least one output token reference, for the token reference register,
wherein the secure element is configured to provide the at least one modification statement as a validity request, and
the secure element is configured to receive a validity confirmation for at least one output token reference of the validity request that is to be checked for validity.

19. The secure element according to claim 18, wherein the validity request comprises the at least one output token reference to be checked and at least one output token reference not to be checked.

20. The secure element according to claim 18, wherein, in addition to the modification statement, the validity request comprises a checking statement which indicates the at least one output token reference to be checked.

21. The secure element according to claim 18, wherein the secure element is configured to provide modification statements either as a validity request or as a registration request.

22. The secure element according to claim 18, wherein the validity confirmation comprises, for each output token reference to be checked, a separate cryptographic confirmation which is stored in the secure element; or
the validity confirmation comprises, for all the output token references to be checked, a common cryptographic confirmation which is stored in the secure element.

23. The secure element according to claim 18, wherein the validity request comprises a plurality of modification statements, comprises a stack and/or a sequence of modification statements.

24. The secure element according to claim 18, wherein the secure element further comprises a processor, in particular for carrying out the steps as a transaction unit, and/or an interface, in particular to a local terminal, via which the validity request for the token reference register is provided; and/or
tokens as data elements comprise a token value and a secret token element; and/or
token references as data elements comprise a token value and a public token element.

25. A method for checking the validity of a token of a secure electronic transaction system,
wherein each token of the transaction system is uniquely assigned a token reference,
wherein a token reference register of the transaction system comprises a verification unit and a storage unit, in which the token references of valid tokens are stored, having the following method steps in the token reference register:
receiving a validity request comprising a modification statement with at least one input token reference, at least one output token reference and a command;
checking at least one output token reference of the validity request that is to be checked for validity in order to determine whether it is stored in the storage unit; and
sending a validity confirmation for the at least one output token reference to be checked;
wherein the validity request comprises the modification statement to be processed only as an option and/or a checking statement which indicates the at least one output token reference to be checked.

26. The method according to claim 25, wherein the verification unit processes modification statements using one or more of the following substeps:
checking whether the at least one input token reference is stored in the storage unit;
verifying the modification statement by means of the verification unit, in particular a signature in the modification request and/or a value neutrality of the modification statement and/or a syntax of the modification statement; and/or
executing the command by storing an output token reference in the storage unit and in particular by deleting an input token reference in the storage unit.

27. The method according to claim 25, wherein the validity request comprises at least one output token reference(s) not to be checked for validity; and/or
the validity confirmation comprises a separate cryptographic confirmation for each output token reference to be checked.

28. The method according to claim 25, wherein the validity request comprises a plurality of modification statements,
wherein each modification statement comprises one or more input token references, one or more output token references and a modification command,
wherein the modification statements are a stack of modification statements and/or a sequence of modification statements,
wherein in particular stacks consist of independent modification statements and sequences comprise at least partially interdependent modification statements.

27. The method according to claim 25, wherein the verification unit addresses a common storage query to the storage unit for output token references of different modification statements and/or for output token references and input token references of at least one modification statement.

28. The method according to claim 28, wherein a partial validity confirmation is sent for the stack of modification statements; and/or
for a sequence of modification statements, at least one output token reference of a modification statement is only buffered internally and/or is only stored in the storage unit after checking one, a plurality of or all further modification statements of the sequence.

29. The method according to claim 25, wherein the token reference register carries out the method with a transaction unit TE,
or a secure element according of an electronic transaction system, wherein the secure element has a token store for tokens of the transaction system;
wherein the secure element is configured as a transaction unit in order to exchange tokens of the transaction system directly with another transaction unit of the transaction system;
wherein each token of the transaction system is uniquely assigned a token reference which can be registered in a token reference register of the transaction system;
wherein the secure element is configured to generate at least one output token and its output token reference from at least one input token;
wherein the secure element provides at least one modification statement, which comprises at least one input token reference, a command and at least one output token reference, for the token reference register,
wherein the secure element is configured to provide the at least one modification statement as a validity request, and
the secure element is configured to receive a validity confirmation for at least one output token reference of the validity request that is to be checked for validity;
and/or
the token reference register also comprises:
further verification units and/or an
archive unit which stores token references that are no longer valid and/or validity requests and/or registration requests that have already been executed.

30. A token reference register for a transaction system, configured to carry out the method steps according to claim 25, in particular with a transaction unit TE or a secure element of an electronic transaction system, wherein the secure element has a token store for tokens of the transaction system;
wherein the secure element is configured as a transaction unit in order to exchange tokens of the transaction system directly with another transaction unit of the transaction system;
wherein each token of the transaction system is uniquely assigned a token reference which can be registered in a token reference register of the transaction system;
wherein the secure element is configured to generate at least one output token and its output token reference from at least one input token;
wherein the secure element provides at least one modification statement, which comprises at least one input token reference, a command and at least one output token reference, for the token reference register,
wherein the secure element is configured to provide the at least one modification statement as a validity request, and
the secure element is configured to receive a validity confirmation for at least one output token reference to the validity request that is to be checked for validity.

31. The token reference register according to claim 30, comprising:
the storage unit for storing token references for registering tokens in the transaction system;
an interface configured to receive a validity request;
the at least one verification unit.

32. A transaction system comprising:
a register layer with a token reference register according to claim 30 for registering token references; and
a direct transaction layer having a multiplicity of transaction units, including a secure element of an electronic transaction system, wherein the secure element has a token store for tokens of the transaction system;
wherein the secure element is configured as a transaction unit in order to exchange tokens of the transaction system directly with another transaction unit of the transaction system;
wherein each token of the transaction system is uniquely assigned a token reference which can be registered in a token reference register of the transaction system;
wherein the secure element is configured to generate at least one output token and its output token reference from at least one input token;
wherein the secure element provides at least one modification statement, which comprises at least one input token reference, a command and at least one output token reference, for the token reference register,
wherein the secure element is configured to provide the at least one modification statement as a validity request, and
the secure element is configured to receive a validity confirmation for at least one output token reference of the validity request that is to be checked for validity.
